(19) United States
(12) Patent Application Publication
(10) Pub. No.: US 2013/0231017 A1
(43) Pub. Date: Sep. 5, 2013

(54) PREPREGS BASED ON A STORAGE-STABLE REACTIVE OR HIGHLY REACTIVE POLYURETHANE COMPOSITION

(71) Applicants: Friedrich Georg Schmidt, Haltern am See (DE); Sandra Reemers, Muenster (DE)

(72) Inventors: Friedrich Georg Schmidt, Haltern am See (DE); Sandra Reemers, Muenster (DE)

(73) Assignee: Evonik Degussa GmbH, Essen (DE)

(21) Appl. No.: 13/824,064

(22) PCT Filed: Aug. 31, 2011
(86) PCT No.: PCT/EP11/64942

§ 371 Date: May 9, 2013

(30) Foreign Application Priority Data
Sep. 23, 2010 (DE) 10 2010 041 243.0

(51) Int. Cl. C08L 75/06; D06N 3/14; D06N 3/00

(52) U.S. Cl. CPC C08L 75/06; D06N 3/0015; D06N 3/14
USPC 442/1; 524/590; 442/179

(57) ABSTRACT

The invention relates to prepregs based on a storage-stable reactive or highly reactive polyurethane composition for producing composite components having visible carbon fibre fabrics or scrims.

### STATE OF THE ART

The invention relates to prepregs based on a storage-stable reactive or highly reactive polyurethane composition for producing composite components having visible carbon fibre fabrics or scrims.

Prepregs based on a storage-stable reactive or highly reactive polyurethane composition are known from DE 102009001793, DE 102009001806 and DE 10201029355.

Fibrous composite materials are ever more frequently being processed to give designer objects. The quality appearance of a visible carbon fibre fabric is employed especially in motor vehicle construction, particularly in motor sport, and also in model construction. In addition, the composites (mouldings) have a high structural durability, and high mechanical strengths are also achieved.

The terms “visible carbon”, “visible carbon fabric structure”, “carbon look” and “carbon appearance” are understood to mean that the fibre structure of carbon fibre fabrics or scrims is visible in composites (components), sheets and also films; see Figure A, carbon fibre fabric. Composite components (laminates and/or sandwich components) generally have to be processed to improve or upgrade the surface quality or the visualization of carbon fibre fabrics or carbon fibre scrims. Usually, the articles are either coated with clear coatings or with transparent polymers.

The direct production of corresponding composite components via what is called prepreg technology is a problem which is yet to be solved.

It was an object of the present invention to enable the production of visible carbon composite components with specific prepregs based on a storage-stable reactive or highly reactive polyurethane composition.

The stated object is achieved by prepregs based on storage-stable reactive or highly reactive aliphatic polyurethane compositions with a distinctly reduced fibre content by volume, which are already present in the matrix material composition when the prepreg is produced.

It has been found that the use of specific prepregs which are produced with a reduced fibre content by volume of the carbon fibre fabrics or scrims which are used and are to be made visible, said prepregs being based on aliphatic polyurethane matrices, enables production of light-stable composite components having class A surfaces.

A subject of the invention are prepregs having a fibre content by volume of less than 50%, essentially made up of
A) at least one fibrous support consisting of carbon fibre and
B) at least one reactive or highly reactive transparent polyurethane composition as matrix material,
wherein the polyurethane compositions essentially contain mixtures of a polymer b) having functional groups reactive towards isocyanates as binder and aliphatic, cycloaliphatic and/or (cycloaliphatic) di- or polyisocyanate internally blocked and/or blocked with blocking agents as curing agent a).

The transparent matrix material may additionally comprise suitable light stabilizers and/or oxidation stabilizers.

The inventive prepregs and the composites (components) produced therefrom have a surface with a visible structure of the fibrous support A) used.

The production of the prepregs can in principle be effected by any process.

In a suitable manner, a powdery reactive or highly reactive polyurethane composition B) according to the invention is applied onto the support by powder impregnation, preferably by a dusting process. Also possible are fluidized bed sinter processes, pultrusion or spray processes. The powder (as a whole or a fraction) is preferably applied by dusting processes onto the fibrous support, e.g. onto ribbons of carbon fibre scrims or fibre fabrics, and then fixed. For avoidance of powder losses, the powder-treated fibrous support is preferably heated in a heated section (e.g. with IR rays) directly after the dusting procedure, so that the particles are sintered on, during which temperatures of 80 to 100° C. should not be exceeded, in order to prevent initiation of reaction of the highly reactive matrix material. These prepregs can as required be combined into different forms and cut to size.

The production of the prepregs can also be effected by the direct melt impregnation process. The principle of the direct melt impregnation process for the prepregs consists in that firstly a reactive or highly reactive polyurethane composition B) according to the invention is produced from the individual components thereof. This melt of the powdery reactive polyurethane composition B) according to the invention is then applied directly onto the fibrous support A), in other words an impregnation of the fibrous support A) with the melt from B) is effected. After this, the cooled storable prepregs can be further processed into composites at a later time. Through the direct melt impregnation process according to the invention, very good impregnation of the fibrous support takes place, due to the fact that the then liquid low viscosity reactive polyurethane compositions wet the fibres of the support very well.

The production of the prepregs can also be effected using a solvent. The principle of the process for the production of prepregs then consists in that firstly a solution or dispersion comprising the reactive or highly reactive polyurethane composition B) according to the invention is produced from the individual components thereof in a suitable common solvent. This solution or dispersion of the reactive polyurethane composition B) is then applied directly onto the fibrous support A), whereby the fibrous support becomes soaked/impregnated with this solution. Next, the solvent is removed. Preferably the solvent is removed completely at low temperature, preferably <100° C., e.g. by heat treatment or application of a vacuum. After this, the storable prepregs again freed from the solvent can be further processed to composites at a later time. Through the process according to the invention, very good impregnation of the fibrous support takes place, due to the fact that the solutions of the reactive polyurethane compositions wet the fibres of the support very well.

As suitable solvents for the process according to the invention, all aprotic liquids can be used which are not reactive towards the reactive polyurethane compositions, exhibit adequate solvent power towards the individual components of the reactive polyurethane composition used and can be removed from the prepreg impregnated with the reactive polyurethane composition during the solvent removal process step apart from slight traces (<0.5 weight %), whereby recycling of the separated solvent is advantageous.

By way of example, ketones (acetone, methyl ethyl ketone, methyl isobutyl ketone, cyclo-hexanone), ethers (tetrahydrofuran), esters (n-propyl acetate, n-butyl acetate, isobutyl acetate, 1,2-propylene carbonate, propylene glycol methyl ether acetate) may be mentioned here.

After cooling to room temperature, the prepregs according to the invention exhibit very high storage stability at room temperature, provided that the matrix material exhibits a Tg of at least 40° C. Depending on the reactive polyurethane composition contained this is at least a few days at room temperature, but as a rule the prepregs are storage-stable for several weeks at 40° C. and below. The prepregs thus produced are not sticky and are thus very good for handling and further processing. The reactive or highly reactive polyurethane compositions used according to the invention thus exhibit very good adhesion and distribution on the fibrous support.

During the further processing of the prepregs to composites (composite materials) e.g. by pressing at elevated temperatures, very good impregnation of the fibrous support takes place, due to the fact that the then liquid low viscosity reactive or highly reactive polyurethane compositions before the crosslinking reaction wet the fibres of the support very well, before gelling occurs or the complete polyurethane matrix cures fully due to the crosslinking reaction of the reactive or highly reactive polyurethane composition at elevated temperatures.

The prepregs thus produced can as required be combined into different forms and cut to size.

For the consolidation of the prepregs into a single composite and the crosslinking of the matrix material to give the matrix, the prepregs are cut to size, optionally sewn or otherwise fixed and compressed in a suitable mould under pressure and optionally application of vacuum. In the context of this invention, depending on the curing time this procedure of the production of the composites from the prepregs is effected at temperatures of over about 160° C. with the use of reactive matrix materials (modification I) or at temperatures of over 100° C. with highly reactive matrix materials provided with appropriate catalysts (modification II).

Depending on the composition of the reactive or highly reactive polyurethane composition used and optionally added catalysts, both the rate of the crosslinking reaction in the production of the composite components and also the properties of the matrix can be varied over wide ranges.

In the context of the invention, the reactive or highly reactive polyurethane composition used for the production of the prepregs is defined as the matrix material, and in the description of the prepregs the still reactive or highly reactive polyurethane composition applied onto the fibres by the process according to the invention.

The matrix is defined as the matrix materials from the reactive or highly reactive polyurethane compositions crosslinked in the composite.

Support

The fibrous support in the present invention consists of fibrous material (also often called reinforcing fibres). In general, any material of which the carbon fibres consist is suitable. Carbon fibres are industrially produced fibres made from carbon-containing starting materials which are converted by pyrolysis into carbon in graphite configuration. A distinction is made between isotropic and anisotropic: isotropic fibres have only low strength and lower industrial importance, anisotropic fibres exhibit high strength and rigidity with at the same time low elongation at break.

The fibrous material is a flat textile sheet. Flat textile sheets of non-woven material, also so-called knitted goods, such as hosiery and knitted fabrics, but also non-knitted sheets such as woven fabrics, non-wovens or braided fabrics, are suitable. In addition, a distinction is made between long-fibre and short-fibre materials as supports. All the said materials are suitable as fibrous supports in the context of the invention. An overview of reinforcing fibres is contained in “Composites Technologies, Paolo Ermanni (Version 4), Script for Lecture at ETH Zürich, August 2007, Chapter 7”.

The supports used are preferably fabrics and scrims of carbon fibre.

The fibre content by volume of the prepregs varies, according to the invention, from <50%, preferably <40%, more preferably <35%.

Matrix Material

In principle, all light-stable reactive or highly reactive transparent polyurethane compositions which are storage-stable at room temperature are suitable as matrix materials. According to the invention, suitable polyurethane compositions consist of mixtures of a polymer b) (binder) having functional groups—reactive towards NCO groups, also described as resin, and aliphatic, cycloaliphatic and/or (cyclo)aliphatic di- or polyisocyanates that are temporarily deactivated, in other words internally blocked and/or blocked with blocking agents, also described as curing agents a) (component a)).

As functional groups of the polymers b) (binder), hydroxyl groups, amino groups and thiol groups which react with the free isocyanate groups with addition and thus crosslink and cure the polyurethane composition are suitable. The binder components must be of a solid resin nature (glass transition temperature greater than room temperature). Possible binders are polyesters, polyethers, polyacrylates, polycarbonates and polyurethanes with an OH number of 20 to 500 mg KOH/gram and an average molecular weight of 250 to 6000 g/mole. Particularly preferably hydroxyl group-containing polyesters or polyacrylates with an OH number of 20 to 150 mg KOH/gram and an average molecular weight of 500 to 6000 g/mole are used. Of course, mixtures of such polymers can also be used. The quantity of the polymers b) having functional groups is selected such that for each functional group of the component b) 0.6 to 2 NCO equivalents or 0.3 to 1 uretdione group of the component a) is consumed.

As the curing component a), di and polyisocyanates that are blocked with blocking agents or internally blocked (uretdione) are used.

The di and polyisocyanates used according to the invention can consist of any aliphatic, cycloaliphatic and/or (cyclo)aliphatic di and/or polyisocyanates.

Suitable aliphatic di- or polyisocyanates advantageously possess 3 to 16 carbon atoms, preferably 4 to 12 carbon atoms, in the linear or branched alkylene residue and suitable cycloaliphatic or (cyclo)aliphatic diisocyanates advantageously possess 4 to 18 carbon atoms, preferably 6 to 15 carbon atoms, in the cycloalkylene residue. (Cyclo)aliphatic diisocyanates are adequately understood by those skilled in the art simultaneously to mean cyclically and aliphatically bound NCO groups, as is for example the case with isophorone diisocyanate. In contrast, cycloaliphatic diisocyanates are understood to mean those which only have NCO groups directly bound to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di and triisocyanate, undecane di and triisocyanate, and dodecane di and triisocyanate.

Isophorone diisocyanate (IPDI), hexamethylene diisocyanate (HDI), diisocyanatodicyclohexyl-methane (H₁₂MDI), 2-methylpentane diisocyanate (MPDI), 2,2,4-trimethylhexamethylene diisocyanate/2,4,4-trimethylhexamethylene diisocyanate (TMDI) and norbornane diisocyanate (NBDI) are preferred. Quite particularly preferably IPDI, HDI, TMDI and H₁₂MDI are used, and the isocyanurates are also usable. Also suitable are 4-methyl-cyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate and 1,4-diisocyanato-4-methylpentane.

Of course, mixtures of the di and polyisocyanates can also be used.

Further, oligo or polyisocyanates which can be produced from the said di- or polyisocyanates or mixtures thereof by linking by means of urethane, allophanate, urea, biuret, uretdione, amine, isocyanurate, carbodiimide, uretonimine, oxadiazinetrione or iminooxadiazinedione structures are preferably used. Isocyanurate, in particular from IPDI and HDI, are particularly suitable.

The polyisocyanates used according to the invention are blocked. Possible for this are external blocking agents, such as for example ethyl acetoacetate, diisopropylamine, methyl ethyl ketoxime, diethyl malonate, ε-caprolactam, 1,2,4-triazole, phenol or substituted phenols and 3,5-dimethylpyrazole.

The curing agents preferably used are IPDI adducts which contain isocyanurate groups and ε-caprolactam-blocked isocyanate structures.

Internal blocking is also possible and this is preferably used. The internal blocking occurs via dimer formation via uretdione structures which at elevated temperature cleave back again to the isocyanate structures originally present and hence set the crosslinking with the binder in motion.

Optionally, the reactive polyurethane compositions can contain additional catalysts. These are organometallic catalysts, such as for example dibutyl tin dilaurate (DBTL), tin octoate, bismuth neodecanoate, or else tertiary amines, such as for example 1,4-diazabicyclo[2.2.2]octane, in quantities of 0.001-1 wt. %. These reactive polyurethane compositions used according to the invention are cured under normal conditions, e.g. with DBTL catalysis, beyond 160° C., usually beyond ca. 180° C. and designated as modification I.

For the production of the reactive polyurethane compositions, the additives usual in powder coating technology, such as levelling agents, e.g. polysilicones or acrylates, light stabilizers e.g. sterically hindered amines, or other additives, such as were for example described in EP 669 353, can be added in a total quantity of 0.05 to 5 wt. %.

In the context of this invention, reactive (modification I) means that the reactive polyurethane compositions used according to the invention as described above cure at temperatures beyond 160° C., depending on the nature of the support.

The reactive polyurethane compositions according to the invention are cured under normal conditions, e.g. with DBTL catalysis, beyond 160° C., usually beyond ca. 180° C. The time for the curing of the polyurethane composition used according to the invention as a rule lies within 5 to 60 minutes.

Preferably in the present invention a matrix material B) is used made of a polyurethane composition B) containing uretdione groups, essentially containing
a) at least one uretdione group-containing curing agent, based on polyaddition compounds from aliphatic, (cyclo)aliphatic or cycloaliphatic uretdione group-containing polyisocyanates and hydroxyl group-containing compounds, wherein the curing agent is in solid form below 40° C. and in liquid form above 125° C. and has a free NCO content of less than 5 wt. % and a uretdione content of 3- 25 wt. %,
b) at least one hydroxyl group-containing polymer which is in solid form below 40° C. and in liquid form above 125° C. and has an OH number between 20 and 200 mg KOH/gram,
c) optionally at least one catalyst, and
d) optionally auxiliary agents and additives known from polyurethane chemistry, so that the two components a) and b) are present in the ratio such that for each hydroxyl group of the component b) 0.3 to 1 uretdione group of the component a) is consumed, preferably 0.45 to 0.55. The latter corresponds to a NCO/OH ratio of 0.9 to 1.1 to 1.

Uretdione group-containing polyisocyanates are well known and are for example described in U.S. Pat. No. 4,476,054, U.S. Pat. No. 4,912,210, U.S. Pat. No. 4,929,724 and EP 417 603. A comprehensive overview concerning industrially relevant processes for the dimerization of isocyanates to uretdiones is given in J. Prakt. Chem. 336 (1994) 185-200. In general, the conversion of isocyanates to uretdiones takes place in the presence of soluble dimerization catalysts such as for example dialkylaminopyridines, trialkylphosphines, phosphorous acid triamides or imidazoles. The reaction—optionally performed in solvents, but preferably in the absence of solvents—is stopped by addition of catalyst poisons on attainment of a desired conversion level. Excess monomeric isocyanate is then removed by short path evaporation. If the catalyst is sufficiently volatile, the reaction mixture can be freed from the catalyst in the course of the monomer removal. In this case the addition of catalyst poisons can be omitted. Essentially, a broad range of isocyanates are suitable for the production of uretdione group-containing polyisocyanates. The aforesaid di and polyisocyanates can be used. However, di and polyisocyanates from any aliphatic, cyclo-aliphatic and/or (cyclo)aliphatic di and/or polyisocyanates are preferable. According to the invention, isophorone diisocyanate (IPDI), hexamethylene diisocyanate (HDI), diisocyanato-dicyclohexylmethane (H₁₂MDI), 2-methylpentane diisocyanate (MPDI), 2,2,4-trimethyl-hexamethylene diisocyanate/2,4,4-trimethylhexamethylene diisocyanate (TMDI) or norbornane diisocyanate (NBDI) are used. Quite particularly preferably, IPDI, HDI, TMDI and H₁₂MDI are used, and the isocyanurates are also usable.

Quite particularly preferably, IPDI and HDI are used for the matrix material. The conversion of these uretdione group-containing polyisocyanates to uretdione group-containing curing agents a) comprises the reaction of the free NCO groups with hydroxyl group-containing monomers or polymers, such as for example polyesters, polythioethers, polyethers, polycaprolactams, polyepoxides, polyester amides, polyurethanes or low molecular weight di, tri and/or tetrahydric alcohols as chain extenders and optionally monoamines and/or monohydric alcohols as chain terminators and has already often been described (EP 669 353, EP 669 354, DE 30 30 572, EP 639 598 or EP 803 524).

Preferred curing agents a) having uretdione groups have a free NCO content of less than 5 wt. % and a content of uretdione groups of 3 to 25 wt. %, preferably 6 to 18 wt. % (calculated as C₂N₂O₂, molecular weight 84). Polyesters and monomeric dihydric alcohols are preferred. Apart from the uretdione groups, the curing agents can also have isocyanurate, biuret, allophanate, urethane and/or urea structures.

For the hydroxyl group-containing polymers b), polyesters, polyethers, polyacrylates, polyurethanes and/or polycarbonates with an OH number of 20-200 in mg KOH/gram are preferably used. Polyesters with an OH number of 30-150 and an average molecular weight of 500-6000 g/mole which are in solid form below 40° C. and in liquid form above 125° C. are particularly preferably used. Such binders have for example been described in EP 669 354 and EP 254 152. Of course, mixtures of such polymers can also be used. The quantity of the hydroxyl group-containing polymers b) is selected such that for each hydroxyl group of the component b) 0.3 to 1 uretdione group of the component a), preferably 0.45 to 0.55, is consumed. Optionally, additional catalysts c) can be contained in the reactive polyurethane compositions B) according to the invention. These are organometallic catalysts such as for example dibutyltin dilaurate, zinc octoate, bismuth neodecanoate, or else tertiary amines such as for example 1,4-diazabicyclo[2.2.2]octane, in quantities of 0.001-1 wt. %. These reactive polyurethane compositions used according to the invention are cured under normal conditions, e.g. with DBTL catalysis, beyond 160° C., usually beyond ca. 180° C. and designated as modification I.

For the production of the reactive polyurethane compositions according to the invention, the additives usual in powder coating technology, e.g. polysilicones or acrylates, light stabilizers e.g. sterically hindered amines, oxidation stabilizers or other additives, such as were for example described in EP 669 353, can be added in a total quantity of 0.05 to 5 wt. %.

Suitable oxidation stabilizers are, for example, phenolic antioxidants which contain at least one sterically hindered phenolic moiety. Examples of these phenolic antioxidants are: 2,6-di-tert-butyl-4-methylphenol, 2,4,6-tri-tert-butylphenol, 2,2″-methylenbis(4-methyl-6-tert-butylphenol), 2,2″-thiobis(4-methyl-6-t-butylphenol), 4,4″-thiobis(3-methyl-6-t-butylphenol), 4,4′-butylidenebis-(3-methyl-6-tert-butylphenol), 4,4′-methylidenebis(2,6-di-tert-butylphenol), 2,2′-methylidenebis-[4-methyl-6-(1-methylcyclohexyl)phenol], tetrakis[methylene-3-(3,5-di-tert-butyl-4-hydroxy-phenyl)propionate]methane, 1,3,5-trimethyl-2,4,6-tris(3,5-di-tert-butyl-4-hydroxybenzyl)benzene, N,N′-hexamethylenebis(3,5-di-tert-butyl-4-hydroxyhydrocinnamide), octadecyl 3-(3,5-di-tert-butyl-4-hydroxyphenyl)propionate, 1,3,5-tris(3,5-di-tert-butyl-4-hydroxybenzyl)isocyanurate, 1,1,3-tris(5-tert-butyl-4-hxdroxy-2-methylphenyl)butane, 1,3,5-tris(3,5-di-tert-butyl-4-hydroxy-benzyl)mesitylene; ethylene glycol bis[3,3-bis(3′-tert-butyl-4′-hydroxyphenyl)butyrate], 2,2′-thiodiethyl bis-3-(3,5-di-tert-butyl-4-hydroxyphenyl)propionate, 2,2′-methylenebis(4-methyl-6-cyclohexylphenol), 1,6-hexanediol bis(3,5-di-tert-butyl-4-hydroxyphenyl)propionate, 2,4-bis(n-octylthio)-6-(4-hydroxy-3,5-di-tert-butylanilino)-1,3,5-triazine, diethyl 3,5-di-tert-butyl-4-hydroxy-benzylphosphonate and triethylene glycol bis-3-(tert-butyl-4-hydroxy-5-methylphenyl)-propionate.

Likewise suitable are stabilizers, for example phosphorus compounds, preferably triesters of phosphorous acid, for example trialkyl and triaryl phosphites and thioethers.

Light stabilizers are well known and are described in detail, for example, in Hans Zweifel, Plastics Additives Handbook, Hanser Verlag, 5th Edition, 2001, p. 141 ff. Light stabilizers shall be understood to mean UV absorbers, UV stabilizers and free-radical scavengers.

UV absorbers may originate, for example, from the group of the substituted benzophenones, salicylic esters, cinnamic esters, oxalanilides, benzoxazinones, hydroxyphenylbenzotriazoles, triazines or benzylidene malonate.

It is also possible to use UV absorbers of the benzotriazole type. These UV absorbers are sold, for example, under the TINUVIN P brand (2-(2′-hydroxy-5′-methylphenyl)benzotriazole)) by Ciba Specialty Chemicals Inc.

The best-known representative of the UV stabilizers/free-radical scavengers is the group of the sterically hindered amines (Hindered Amine Light Stabilizers, HALS). These are derivatives of 2,2,6,6-tetramethylpiperidine, for example triacetonamine (2,2,6,6-tetramethyl-4-oxopiperidine).

The reactive polyurethane compositions used according to the invention are cured under normal conditions, e.g. with DBTL catalysis, beyond 160° C., usually beyond ca. 180° C. The reactive polyurethane compositions used according to the invention provide very good flow and hence good impregnation behaviour and in the cured state excellent chemicals resistance. In addition, with the use of aliphatic crosslinking agents (e.g. IPDI or H₁₂MDI) good weather resistance is also achieved.

Particularly preferably in the invention a matrix material is used which is made from
B) at least one highly reactive uretdione group-containing polyurethane composition, essentially containing
   a) at least one uretdione group-containing curing agent based on aliphatic, (cyclo)aliphatic or cycloaliphatic uretdione group-containing di- or polyisocyanates, and
   b) optionally at least one polymer with functional groups reactive towards NCO groups;
   c) 0.1 to 5 wt. % of at least one catalyst selected from quaternary ammonium salts and/or quaternary phosphonium salts with halogens, hydroxides, alcoholates or organic or inorganic acid anions as counter-ion; and
   d) 0.1 to 5 wt. % of at least one cocatalyst, selected from
      d1) at least one epoxide and/or
      d2) at least one metal acetylacetonate and/or quaternary ammonium acetylacetonate and/or quaternary phosphonium acetylacetonate; and
   e) optionally auxiliary agents and additives known from polyurethane chemistry.

Quite especially, a matrix material B) made from
B) at least one highly reactive powdery uretdione group-containing polyurethane composition as matrix material, essentially containing
   a) at least one uretdione group-containing curing agent, based on polyaddition compounds from aliphatic, (cyclo)aliphatic or cycloaliphatic uretdione group-containing polyisocyanates and hydroxyl group-containing compounds, wherein the curing agent is in solid form below 40° C. and in liquid form above 125° C. and has a free NCO content of less than 5 wt. % and a uretdione content of 3-25 wt. %,
   b) at least one hydroxyl group-containing polymer which is in solid form below 40° C. and in liquid form above 125° C. and has an OH number between 20 and 200 mg KOH/gram;
   c) 0.1 to 5 wt. % of at least one catalyst selected from quaternary ammonium salts and/or quaternary phosphonium salts with halogens, hydroxides, alcoholates or organic or inorganic acid anions as counter-ion; and
   d) 0.1 to 5 wt. % of at least one cocatalyst, selected from
      d1) at least one epoxide and/or
      d2) at least one metal acetylacetonate and/or quaternary ammonium acetylacetonate and/or quaternary phosphonium acetylacetonate; and
   e) optionally auxiliary agents and additives known from polyurethane chemistry, is used so that the two components a) and b) are present in the ratio such that for each hydroxyl group of the component b) 0.3 to 1 uretdione group of the component a) is consumed, preferably 0.6 to 0.9. The latter corresponds to a NCO/OH ratio of 0.6 to 2 to 1 or 1.2 to 1.8 to 1 respectively. These highly reactive polyurethane compositions used according to the invention are cured at temperatures of 100 to 160° C. and designated as modification II.

Suitable highly reactive uretdione group-containing polyurethane compositions according to the invention contain mixtures of temporarily deactivated, that is uretdione group-containing (internally blocked) di- or polyisocyanates, also described as curing agents a), and the catalysts c) and d) contained according to the invention and optionally in addition a polymer (binder) having functional groups—reactive towards NCO groups—also described as resin b). The catalysts ensure curing of the uretdione group-containing polyurethane compositions at low temperature. The uretdione group-containing polyurethane compositions are thus highly reactive.

As component a) and b), those such as described above are used.

As catalysts under c), quaternary ammonium salts, preferably tetraalkylammonium salts and/or quaternary phosphonium salts with halogens, hydroxides, alcoholates or organic or inorganic acid anions as counter-ion, are used. Examples of these are: Tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate and tetrabutylphosphonium acetate, tetrabutylphosphonium formate and ethyltriphenylphosphonium acetate, tetrabutylphosphonium benzotriazolate, tetraphenylphosphonium phenolate and trihexyltetradecyiphosphonium decanoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, tri-methyiphenylammonium hydroxide, triethylmethylammonium hydroxide, tri-methylvinylammonium hydroxide, methyltributylammonium methanolate, methyltriethylammonium methanolate, tetramethylammonium methanolate, tetraethylammonium methanolate, tetrapropylammonium methanolate, tetrabutylammonium methanolate, tetrapentylammonium methanolate, tetrahexylammonium methanolate, tetraoctylammonium methanolate, tetradecylammonium methanolate, tetradecyltrihexylammonium methanolate, tetraoctadecylammonium methanolate, benzyltrimethylammonium methanolate, benzyltriethylammonium methanolate, trimethyiphenylammonium methanolate, triethylmethylammonium methanolate, trimethylvinylammonium methanolate, methyltributylammonium ethanolate, methyltriethylammonium ethanolate, tetramethylammonium ethanolate, tetraethylammonium ethanolate, tetrapropylammonium ethanolate, tetrabutylammonium ethanolate, tetrapentylammonium ethanolate, tetrahexylammonium ethanolate, tetraoctylammonium methanolate, tetradecylammonium ethanolate, tetradecyltrihexylammonium ethanolate, tetraoctadecylammonium ethanolate, benzyltrimethylammonium ethanolate, benzyltriethylammonium ethanolate, trimethyiphenylammonium ethanolate, triethylmethylammonium ethanolate, trimethylvinylammonium ethanolate, methyltributylammonium benzylate, methyltriethylammonium benzylate, tetramethylammonium benzylate, tetraethylammonium benzylate, tetrapropylammonium benzylate, tetrabutylammonium benzylate, tetrapentylammonium benzylate, tetrahexylammonium benzylate, tetraoctylammonium benzylate, tetradecylammonium benzylate, tetradecyltrihexylammonium benzylate, tetraoctadecylammonium benzylate, benzyltrimethylammonium benzylate, benzyltriethylammonium benzylate, trimethyiphenylammonium benzylate, triethylmethylammonium benzylate, trimethylvinylammonium benzylate, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutyiphosphonium fluoride, tetrabutylammonium chloride, tetrabutylammonium bromide, tetrabutylammonium iodide, tetraethylammonium chloride, tetraethylammonium bromide, tetraethylammonium iodide, tetramethylammonium chloride, tetramethylammonium bromide, tetramethylammonium iodide, benzyltrimethylammonium chloride, benzyltriethylammonium chloride, benzyltripropylammonium chloride, benzyltributylammonium chloride, methyltributylammonium chloride, methyltripropylammonium chloride, methyltriethylammonium chloride, methyltriphenylammonium chloride, phenyltrimethylammonium chloride, benzyltrimethylammonium bromide, benzyltriethylammonium bromide, benzyltripropylammonium bromide, benzyltributylammonium bromide, methyltributylammonium bromide, methyltripropylammonium bromide, methyltriethylammonium bromide, methyltriphenylammonium bromide, phenyltrimethylammonium bromide, benzyltrimethylammonium iodide, benzyltriethylammonium iodide, benzyltripropylammonium iodide, benzyltributylammonium iodide, methyltributylammonium iodide, methyltripropylammonium iodide, methyltriethylammonium iodide, methyltriphenylammonium iodide and phenyltrimethylammonium iodide, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride. These catalysts can be added alone or in mixtures. Tetraethylammonium benzoate and tetrabutylammonium hydroxide are preferably used.

The content of catalysts c) can be 0.1 to 5 wt. %, preferably from 0.3 to 2 wt. %, based on the total formulation of the matrix material.

One modification according to the invention also includes the binding of such catalysts c) to the functional groups of the polymers b). Apart from this, these catalysts can be surrounded by an inert shell and be enapsulated thereby.

As cocatalysts d1) epoxides are used. Possible here are for example glycidyl ethers and glycidyl esters, aliphatic epoxides, diglycidyl ethers based on bisphenol A and glycidyl methacrylates. Examples of such epoxides are triglycidyl isocyanurate (TGIC, trade name ARALDIT 810, Huntsman), mixtures of diglycidyl terephthalate and triglycidyl trimellitate (trade name ARALDIT PT 910 and 912, Huntsman), glycidyl esters of versatic acid (trade name KARDURA E10, Shell), 3,4-epoxycyclohexylmethyl 3′,4′-epoxycyclohexanecarboxylate (ECC), diglycidyl ethers based on bisphenol A (trade name EPIKOTE 828, Shell), ethylhexyl glycidyl ether, butyl glycidyl ether, pentaerythritol tetraglycidyl ether (trade name POLYPOX R 16, UPPC AG) and other polypox types with free epoxy groups. Mixtures can also be used. Preferably ARALDIT PT 910 and 912 are used.

As cocatalysts d2), metal acetylacetonates are possible. Examples of these are zinc acetylacetonate, lithium acetylacetonate and tin acetylacetonate, alone or in mixtures. Zinc acetylacetonate is preferably used.

As cocatalysts d2), quaternary ammonium acetylacetonates or quaternary phosphonium acetylacetonates are also possible.

Examples of such catalysts are tetramethylammonium acetylacetonate, tetraethylammonium acetylacetonate, tetrapropylammonium acetylacetonate, tetrabutylammonium acetylacetonate, benzyltrimethylammonium acetylacetonate, benzyltriethylammonium acetylacetonate, tetramethylphosphonium acetylacetonate, tetraethylphosphonium acetylacetonate, tetrapropylphosphonium acetylacetonate, tetrabutylphosphonium acetylacetonate, benzyltrimethylphosphonium acetylacetonate and benzyltriethylphosphonium acetylacetonate. Particularly preferably, tetraethylammonium acetylacetonate and tetrabutylammonium acetylacetonate are used. Of course mixtures of such catalysts can also be used.

The quantity of cocatalysts d1) and/or d2) can be from 0.1 to 5 wt. %, preferably from 0.3 to 2 wt. %, based on the total formulation of the matrix material.

For the production of the highly reactive polyurethane compositions according to the invention, the additives usual in powder coating technology, such as levelling agents, e.g. polysilicones or acrylates, light stabilizers, e.g. sterically hindered amines, oxidation stabilizers or other additives, such as were, for example, described in EP 669 353, can be added in a total amount of 0.05 to 5% by weight, as already described above.

By means of the highly reactive and thus low temperature curing polyurethane compositions B) used according to the invention, at 100 to 160° C. curing temperature not only can energy and curing time be saved, but many temperature-sensitive supports can also be used.

In the context of this invention, highly reactive (modification II) means that the uretdione group-containing polyurethane compositions used according to the invention cure at temperatures from 100 to 160° C., depending on the nature of the support. This curing temperature is preferably 120 to 150° C., particularly preferably from 130 to 140° C. The time for the curing of the polyurethane composition used according to the invention lies within from 5 to 60 minutes.

The highly reactive uretdione group-containing polyurethane compositions B) used according to the invention provide very good flow and hence good impregnation behaviour and in the cured state excellent chemicals resistance. In addition, with the use of aliphatic crosslinking agents (e.g. IPDI or H₁₂MDI) particularly good weather resistance is also achieved.

The production of the matrix material can be effected as follows: the homogenization of all components for the production of the polyurethane composition B) can be effected in suitable units, such as for example heatable stirred vessels, kneaders, or even extruders, during which temperature upper limits of 120 to 130° C. should not be exceeded. The mixing of the individual components is preferably effected in an extruder at temperatures which are above the melting ranges of the individual components, but below the temperature at which the crosslinking reaction starts. Use directly from the melt or after cooling and production of a powder is possible thereafter. The production of the polyurethane composition B) can also be effected in a solvent by mixing in the aforesaid units.

Next, depending on the process, the matrix material B) with the support A) is processed into the prepregs.

The reactive or highly reactive polyurethane compositions used according to the invention as matrix material essentially consist of a mixture of a reactive resin and a curing agent. After melt homogenization, this mixture has a Tg of at least 40° C. and as a rule reacts only above 160° C. in the case of the reactive polyurethane compositions, or above 100° C. in the case of the highly reactive polyurethane compositions, to give a crosslinked polyurethane and thus forms the matrix of the composite. This means that the prepregs according to the invention after their production are made up of the support and the applied reactive polyurethane composition as matrix material, which is present in noncrosslinked but reactive form.

The prepregs are thus storage-stable, as a rule for several days and even weeks and can thus at any time be further processed into composites. This is the essential difference from the 2-component systems already described above, which are reactive and not storage-stable, since after application these immediately start to react and crosslink to give polyurethanes.

The prepreg according to the invention, based on lightfast, storage-stable reactive or highly reactive polyurethane compositions are used in the form of a transparent top layer in the production of composite components. The exceptional transparent surface quality is expressed by a distinct increase in the matrix to fibre ratio (in order words: a very low fibre content by volume). Accordingly, it has a relatively low fibre content by volume. For an especially smooth transparent composite component surface, a fibre content by volume of <50%, preferably <40%, particularly preferably <35% is set.

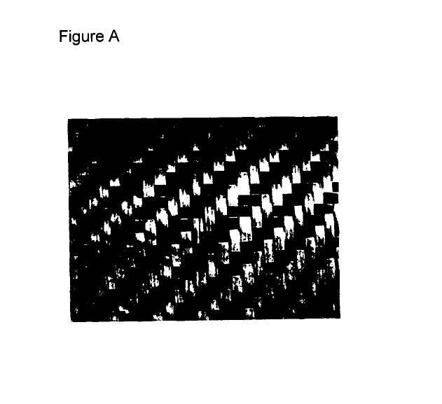

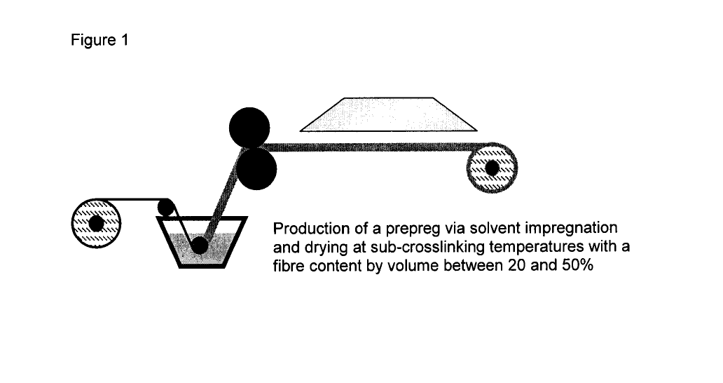

FIG. 1 shows, by way of example, the production of a prepreg according to the invention.

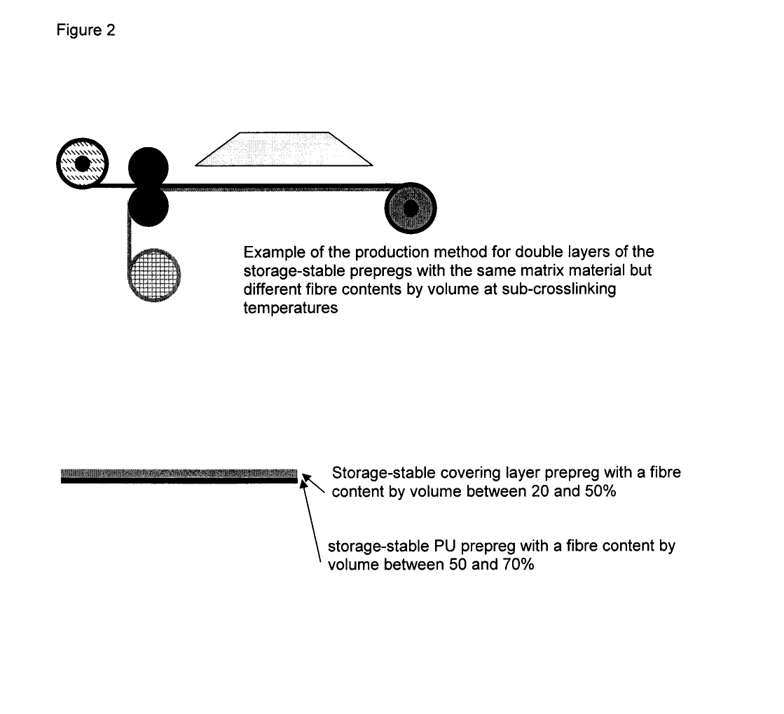

FIG. 2 shows an example of the production method of double layers of the storage-stable prepregs with the same matrix material but different fibre contents by volume.

The production of the prepregs according to the invention can be performed by means of the known plants and equipment by reaction injection moulding (RIM), reinforced reaction injection moulding (RRIM), pultrusion processes, by application of the solution in a cylinder mill or by means of a hot doctor knife, or other processes.

Also subject matter of the invention is the use of the prepregs, in particular with fibrous supports of carbon fibres.

Also subject matter of the invention is the use of the prepregs produced according to the invention, for the production of composite components in boat and shipbuilding, in aerospace technology, in automobile manufacture, and for two-wheel vehicles, preferably motorcycles and bicycles, and in the construction, medical engineering and sport fields, electrical and electronics industry and/or for components for power generating plants, e.g. for rotor blades in wind power plants.

Also subject matter of the invention are the composite components produced from the prepregs produced according to the invention, wherein the composites (components) produced have a surface with a visible structure of the fibrous support A) used.

### EXAMPLES

Reactive Polyurethane Composition

A reactive polyurethane composition with the following formula was used for the production of the prepregs and the composites.

| | Formulation [Modification I] |
|---|---|
| | (according to invention) |
| Example | in wt. % |
| VESTAGON BF 1321 | 33.4 |
| (uretdione group-containing curing agent | |
| component a)), Evonik Degussa | |
| Reafree 17014 | 46.8 |
| (OH-functional polyester resin component, | |
| from Cray Valley) | |
| Reafree 17091 | 16.3 |
| (OH-functional polyester resin component, | |
| from Cray Valley) | |
| Resiflow PV 88 | 1 |
| (levelling agent, from Worlee) | |
| Benzoin (devolatilizer, from Aldrich) | 0.5 |
| NCO:OH ratio | 0.9:1 |

The milled ingredients from the table are intimately mixed in a premixer and then homogenized in the extruder up to a maximum of 130° C. After this, this reactive polyurethane composition can be used for the production of the prepregs depending on the production process. This reactive polyurethane composition can then after milling be used for the production of the prepregs by the powder impregnation process. For the direct melt impregnation process, the homogenized melt mixture produced in the extruder can be used directly.

DSC Measurements

The DSC tests (glass transition temperature determinations and enthalpy of reaction measurements) are performed with a Mettler Toledo DSC 821e as per DIN 53765.

The glass transition temperature of the extrudate was determined to be 61° C.; the reaction enthalpy for the crosslinking reaction in the fresh state was 67.5 J/g.

After the crosslinking (the curing of the prepreg, the laminate production), the glass transition temperature rose to 78° C. and no heat flow for crosslinking was detectable any longer.

Production of the Prepregs

The production of the prepregs is effected by direct melt impregnation processes according to DE 102010029355.

Storage Stability of the Prepregs

The storage stability of the prepregs was determined from the glass transition temperatures and the enthalpies of reaction of the crosslinking reaction by means of DSC studies.

The crosslinking capacity of the PU prepregs is not impaired by storage at room temperature for a period of 5 weeks.

| Time (days | | enthalpy of |
|---|---|---|
| storage time) | Tg [° C.] | curing [J/g] |
| 2 | 62 | 67 |
| 14 | 61 | 68 |
| 28 | 62 | 67 |
| 35 | 62 | 66 |

Composite Component Production

The composite components are produced on a composite press by a compression technique known to those skilled in the art. The homogeneous prepregs produced by direct impregnation were compressed into composite materials on a benchtop press. This benchtop press is the Polystat 200 T from the firm Schwabenthan, with which the prepregs are compressed to the corresponding composite sheets at temperatures between 120 and 200° C. The pressure is varied between normal pressure and 450 bar. Dynamic compression, i.e. alternating applications of pressure, can prove advantageous for the crosslinking of the fibres depending on the component size, thickness and polyurethane composition and hence the viscosity setting at the processing temperature.

In one example, the temperature of the press is increased from 90° C. during the melting phase to 110° C., the pressure is increased to 450 bar after a melting phase of 3 minutes, during which the temperature is continuously increased to 140° C. Next the temperature is raised to 180° C. and at the same time the pressure is held at 350 bar until the removal of the composite component from the press after 30 minutes. The hard, rigid, chemicals resistant and impact resistant composite components (sheet products) with a fibre volume content of >50% are tested for the degree of curing (determination by DSC). The determination of the glass transition temperature of the cured matrix indicates the progress of the crosslinking at different curing temperatures. With the polyurethane composition used, the crosslinking is complete after ca. 30 minutes, and then an enthalpy of reaction for the crosslinking reaction is also no longer detectable.

1. A prepreg, consisting essentially of:
at least one fibrous support consisting of carbon fiber and
at least one reactive or highly reactive transparent polyurethane composition as matrix material,
wherein the at least one polyurethane composition consists essentially of at least one mixture of a polymer comprising at least one functional group reactive towards an isocyanate as binder, and at least one di- or polyisocyanate,
the at least one di- or polyisocyanate is an aliphatic di- or polyisocyanate, a cycloaliphatic di- or polyisocyanate, a (cyclo)aliphatic di- or polyisocyanate, or any combination thereof, and is internally blocked, blocked, or both, with at least one blocking agent as at least one curing agent, and
the prepreg has a fiber content by volume of less than 50%.

2. The prepreg according to claim 1, wherein the matrix material has a Tg of at least 40° C.

3. The prepreg according to claim 1, wherein the prepreg has a surface with a visible structure of the carbon fiber of the at least one fibrous support.

4. The prepreg according to claim 1, wherein a fiber content by volume is <50%.

5. The prepreg according to claim 1, wherein a fibrous support of the at least one fibrous support is a fabric or a scrim.

6. The prepreg according to of claim 1,
wherein the polymer has at least one selected from the group consisting of a hydroxyl group, an amino group, and a thiol group, and
the polymer has an OH number of from 20 to 500 mg KOH/gram and an average molecular weight of from 250 to 6000 g/mole.

7. The prepreg according to claim 1, wherein a starting compound for the at least one di- or polyisocyante is isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethyl-hexamethylene diisocyanate (TMDI), norbornane diisocyanate (NBDI), an isocyanurate, or any combination thereof.

8. The prepreg according to claim 1,
wherein the at least one blocking agent is an external blocking agent selected from the group consisting of ethyl acetoacetate, diisopropylamine, methyl ethyl ketoxime, diethyl malonate, ε-caprolactam, 1,2,4-triazole, phenol, a substituted phenol, and 3,5-dimethylpyrazole.

9. The prepreg according to claim 1,
wherein the at least one di- or polyisocyanate is an IPDI adduct, an isocyanurate group, an ε-caprolactam blocked isocyanate structure, or any combination thereof.

10. The prepreg according to claim 1,
wherein from 0.001 to 1 wt % of the at least one polyurethane composition is at least one additional catalyst.

11. The prepreg according to claim 1,
wherein the at least one polyurethane composition consists essentially of:
at least one uretdione group-comprising curing agent based on at least one polyaddition compound from an aliphatic polyisocyanate, a (cyclo)aliphatic polyisocyanate, a cycloaliphatic polyisocyanate, or a hydroxyl group-comprising compound, wherein the curing agent is in solid form below 40° C. and in liquid form above 125° C., and has a free NCO content of less than 5 wt. % and a uretdione content of from 3-25 wt. %,
at least one hydroxyl group-comprising polymer which is in solid form below 40° C. and in liquid form above 125° C. and has an OH number between 20 and 200 mg KOH/gram,
optionally at least one catalyst, and
optionally at least one auxiliary agent or additive,
and wherein, for each hydroxyl group of the at least one hydroxyl group-comprising polymer, 0.3 to 1 uretdione group of the at least one uretdione is consumed.

12. The prepreg according to claim 1,
wherein a composition of the at least one polyurethane composition is at least one highly reactive powdery polyurethane composition, consisting essentially of:
at least one uretdione group-comprising curing agent based on an aliphatic di-or polyisocyanate, a (cyclo)aliphatic di-or polyisocyanate, a cycloaliphatic di- or polyisocyanate, or any combination thereof;
optionally at least one polymer with at least one functional group reactive towards an NCO group;
from 0.1 to 5 wt. % of at least one catalyst selected from the group consisting of a quaternary ammonium salt and a quaternary phosphonium salt with a halogen, a hydroxide, an alcoholate, or an organic or inorganic acid anion as counter-ion;
from 0.1 to 5 wt. % of at least one cocatalyst, selected from the group consisting of an epoxide a metal acetylacetonate, a quaternary ammonium acetylacetonate, and a quaternary phosphonium acetylacetonate; and
optionally at least one auxiliary agent or additive.

13. The prepreg according to claim 1
wherein a composition of the at least one polyurethane composition is at least one highly reactive powdery polyurethane composition consisting essentially of:
at least one uretdione group-comprising curing agent based on at least one polyaddition compound from an aliphatic polyisocyanate, a (cyclo)aliphatic polyisocyanate, a cycloaliphatic polyisocyanate, or a hydroxyl group-comprising compound, wherein the curing agent is in solid form below 40° C. and in liquid form above 125° C. and has a free NCO content of less than 5 wt. % and a uretdione content of from 3-25 wt. %;
at least one hydroxyl group-comprising polymer which is in solid form below 40° C. and in liquid form above 125° C. and has an OH number between 20 and 200 mg KOH/gram;
from 0.1 to 5 wt. % of at least one catalyst selected from the group consisting of a quaternary ammonium salt and a quaternary phosphonium salt with a halogen, a hydroxide, an alcoholate, or an organic or inorganic acid anion as counter-ion;
from 0.1 to 5 wt. % of at least one cocatalyst selected from the group consisting of an epoxide a metal acetylacetonate, a quaternary ammonium acetylacetonate, and a quaternary phosphonium acetylacetonate; and
optionally at least one auxiliary agent or additive
and wherein, for each hydroxyl group of the at least one hydroxyl group-comprising polymer, 0.3 to 1 uretdione group of the at least one uretdione group-comprising curing agent is consumed.

14-15. (canceled)

16. A composite component obtained by a process comprising producing the composite component with the prepreg of claim 1,
wherein the composite component has a fiber content by volume of less than 50%.

17. A composite component obtained by a process comprising producing the composite component with the prepreg of claim 1,
wherein the composite component has a surface with a visible structure of the at least one fibrous support.

18. A process of producing a composite, the process comprising producing a composite with the prepreg according to claim 1.

19. A process of producing a composite, the process comprising producing a composite with the prepreg according to claim 1,
wherein the prepreg is suitable for boat and ship building; aerospace technology; automobile manufacturing; two-wheel vehicle manufacturing; automotive, construction, medical technology, or sport fields; or an electrical and electronics industry or power generation plant.
